(19) United States
(12) Patent Application Publication
(10) Pub. No.: US 2021/0287313 A1
(43) Pub. Date: Sep. 16, 2021

(54) SYSTEMS AND METHODS FOR PROPERTY TITLE EVALUATION

(71) Applicant: TitleGen, Inc., Newburyport, MA (US)

(72) Inventor: Michael B. McCarthy, West Newbury, MA (US)

(21) Appl. No.: 17/180,635

(22) Filed: Feb. 19, 2021

Related U.S. Application Data
(60) Provisional application No. 62/978,469, filed on Feb. 19, 2020.

(51) Int. Cl. G06Q 50/16; G06Q 10/10

(52) U.S. Cl. CPC G06Q 50/16; G06Q 10/10

(57) ABSTRACT

Embodiments described herein enable the researching and evaluating of titles to pieces of real property using data sources.

### RELATED APPLICATION

This application claims benefit of priority to U.S. Provisional Application No. 62/978,469 filed Feb. 19, 2020, the contents of which is hereby incorporated in its entirety.

### BACKGROUND

When purchasing a property, a title search is often conducted to ensure that marketable title to the property can be obtained and that no encumbrances affect the property rights of the purchasing party. The title search is a process in which public records and other documentation about a property are examined to ensure the property is able to be sold and its title is free of any claims, liens or other issues that could jeopardize your ability to legally own the property.

### BRIEF DESCRIPTION OF DRAWINGS

To assist those of skill in the art in making and using a system for property title evaluation and associated methods, reference is made to the accompanying figures. The accompanying figures, which are incorporated in and constitute a part of this specification, illustrate one or more embodiments and, together with the description, help to explain the embodiments. Illustrative embodiments are shown by way of example in the accompanying drawings and should not be considered as limiting. In the figures:

FIG. 1 illustrates an exemplary network environment suitable for a system for researching and evaluating titles to pieces of real property, in accordance with an exemplary embodiment.

FIG. 2 illustrates a flowchart of steps for using a possible name and address to determine relevant metadata artifacts when retroactively building a genesis block for a real estate title chain, in accordance with an exemplary embodiment.

FIG. 3 illustrates generating an automated deed history pipeline, in accordance with an exemplary embodiment.

FIG. 4 illustrates generating an automated mortgage/discharge history pipeline, in accordance with an exemplary embodiment.

FIG. 5 illustrates generating an automated relevant document history pipeline, in accordance with an exemplary embodiment.

FIG. 6 illustrates an exemplary user interface in accordance with exemplary embodiments.

FIG. 7 is a block diagram of an example computing device that can be used to perform one or more steps of the methods provided by exemplary embodiments.

FIG. 8 illustrates a programmatic interface, in accordance with an example embodiment.

FIGS. 9A-9B illustrate a title summary document (title abstract) created by the disclosed systems and methods, in accordance with an example embodiment.

FIG. 10 illustrates a list of deeds generated by the disclosed systems and methods, in accordance with an example embodiment.

FIG. 11 is a method for property title evaluation in accordance with an exemplary embodiment.

FIG. 12 is a method for property title evaluation in accordance with an exemplary embodiment.

### DETAILED DESCRIPTION

Generating a title abstract can include identifying records associated with a particular parcel of real property. These records can include computer databases as well as physical searches of records at local level record repositories, e.g., county records buildings. If a defect is identified, it typically needs to be resolved (e.g., a lien removed), or potentially excluded from coverage, before title insurance is issued.

In one embodiment, a user, such as a real estate attorney, uses computer implemented systems, methods, and apparatus, to conduct one or more searches for documents related to a parcel of real property. The search results are analyzed and evaluated using computer implemented systems, methods, apparatus to generate a chronological transaction history for the parcel of real property of interest.

The chronological transaction history, in various aspects, may include information related to, but not limited to, one or more of the following: mortgages, discharges, assignments, subordinate mortgages, municipal liens, assignments of rents and leases, assignments of plans, specification and approvals, deeds, trustees of deeds, a declaration of homestead, a taking, an order of conditions, a license agreement, a notice of alternative sewage disposal system, a declaration of restrictive covenant, protective covenants, a partial release for restrictive covenant, a zoning decision, a planning board decision, an order of resource area delineation, a superseding order of conditions, a certificate of compliance, a regulatory agreement, a permit, a comprehensive permit, a betterment, an assessment, easements, rights of way, executions of attachments, federal tax liens, state tax liens, municipal liens, foreclosures, estate liens, releases of liens, divorce related information, floor plans, book and page numbers of recordation, site plans, and condominium documents such as a master deed, declaration of trust, amendments to the master dead, amendments to the declaration of trust, and rights of first refusals.

The transaction history produced by embodiments can be used by real estate professionals, such as a real estate attorney, to insure a title to a parcel of real property and increase efficiency in the mortgage closing process.

Some technologies directed to addressing certain aspects of title issues exist. For example, Block Chain and HyperLedgers are designed to address aspects of the title insurance process through the use of chaining artifacts from their conception. Another concept is the use of referential data management systems (RDMS). These RDMS system are designed to build relationships between Table structures. RDMS systems contain relationships built on pure data structure principles. This enables RDMS systems to locate and reference data with a predefined data structure relationship for reference. However, the relationships contain no Business Logic or decision-making intelligence. RDMS systems also do not create a new artifact from a relationship; they purely make the data available by reference.

Embodiments described herein enable the researching, evaluating, and insuring of titles to pieces of real property using data sources that span various time periods, e.g., as long as fifty years. The disclosed systems and methods address some of the short-comings of existing technologies. The disclosed systems and methods are directed to attempting to verify the integrity of a document, identifying references within the documents, and locating artifacts of the document that relate to a parcel of real property. The process may include one or more of the following steps, as described in detail herein:
1.) Data Collection/Discovery;
2.) Data Analysis/Digestion and Iteration;
3.) Data Organization:

a.) (Inclusion/Exclusion/Discrimination);
4.) Artifact Generation:

a.) (Document preparation, Chronological checks, Industry Rules); and
5.) Summarization:

a.) (Summary sheet to expose Relationships).

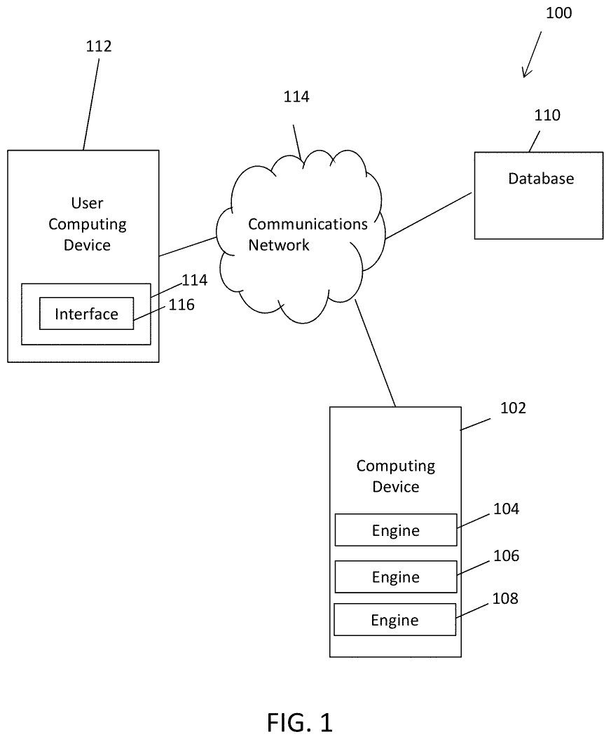

FIG. 1 illustrates an exemplary network environment suitable for a system 100 for researching and evaluating titles to pieces of real property as described herein, in accordance with an exemplary embodiment. System 100 includes at least one computing device 102 executing an automation engine 104, an optical character recognition or optical character reader (OCR) engine 106, and a natural language processing (NLP) engine 108, at least one database 110, and at least one user computing device 112.

The computing device 102, particularly the OCR engine 106, utilizes tools for object character recognition (OCR). For example, Teseract™ and ABBY™ can provide aspects of OCR functionality. In addition, the computing device 102, particularly the NLP engine 108, utilizes tools for natural language processing (NLP). For example, Core™ NLP (from Stamford University) and Watson™ NLP (from IBM) can be used to provide aspects of NLP and NLP functionality. Various combinations of these and other artificial intelligence (AI) technologies may be used as well. For example, computing device 102 may utilize ICR, which is a technology that may be required prior to 1970's when documents were a mix of printed and hid written content. Other forms of deep learning techniques may be utilized to allow for smart document reading and overlay to determine common Entities. An entity type system may be utilized to expand on the ability to instrument a custom Entity Model with Industry specific Entity types and Dictionary for real estate title specific document understanding.

In one embodiment, the database 110 includes one or more of an online property deed registry or a mortgage registry. For example, local (e.g. state, county, city, town) governments may maintain an online accessible database where users can search for, get copies of, or update property ownership records, such as deeds and mortgages (for example, https://www.masslandrecord.com/).

The computing device 102 extracts data from database 110 in the form of deed documents and mortgage documents including mortgage discharges. Every document in a registry to date is submitted as a PDF Image. Each image is a legal document received and recorded by the registry at time of transaction or correction. The computing device 102 downloads any image associated with the search criteria. If a document is available and requires validation, the PDF image is downloaded and analyzed as an image by the OCR engine 106 for character reading.

In addition, the metadata associated with each document is also “downloaded” by the computing device 102 for review and data capture. Each registry may maintain metadata associated with the file submitted by attorneys when recorded. The metadata attempts to define the document type, town, date, consideration, grantors/grantees, locus, street, parties involved, references to other documents, legal instrument type, book of record, page of record, description, and registry.

IN an exemplary embodiment, the computing device 102 obtains the data from the registry by perform API requests. In situations where registry records are stored in outdated monolithic systems with no API or SQL access, a Web Browsing robot is created to perform search automation that matches that of a human search. This is a training operation where the title examiner demonstrates how they perform the search and the computing device 102 learns and replays that very search method. This requires a unique robot for each unique registry technology. However, each Registry may have different levels of technical capabilities, and if possible, the computing device 102 interacts with the Datalayer (DB or API) and not with the presentation layer (Web Page/Search engine).

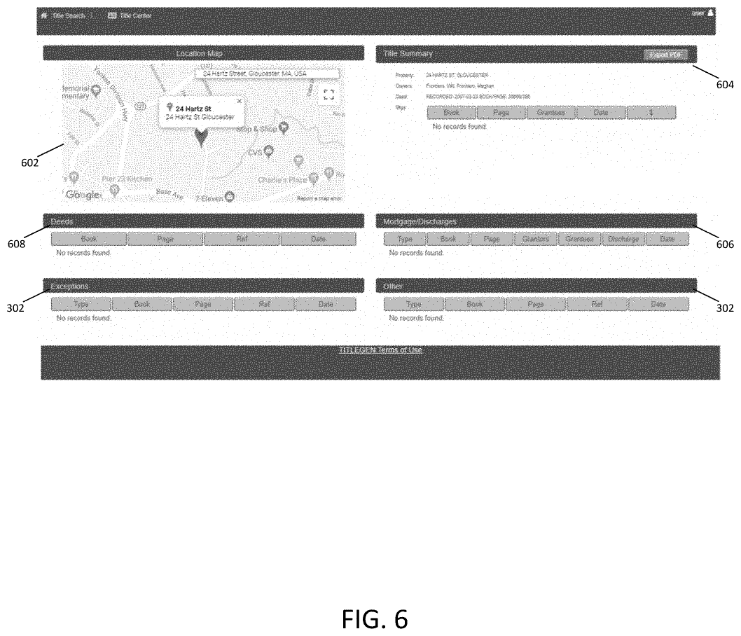

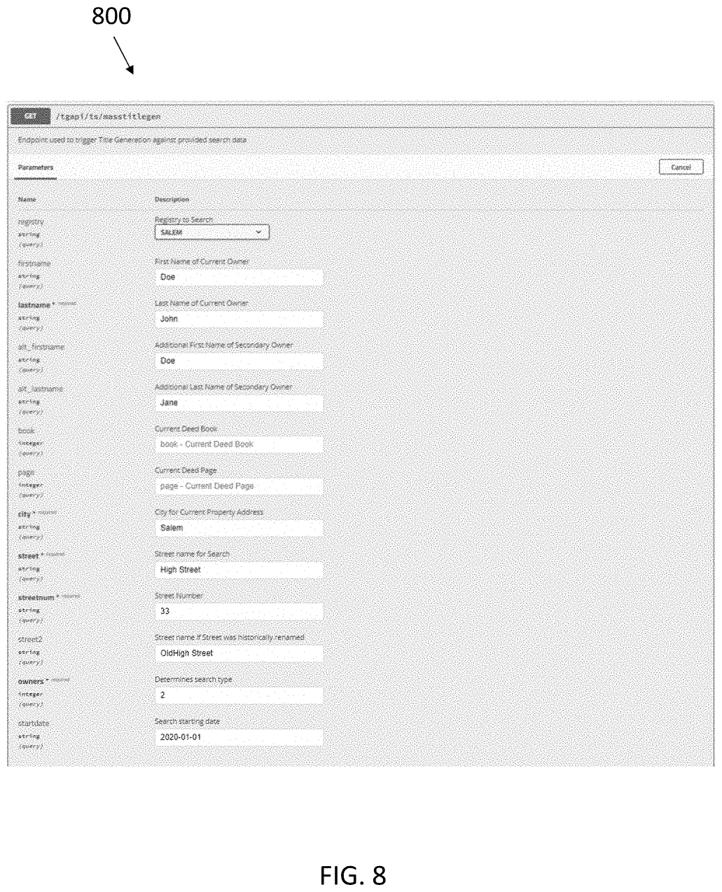

In an exemplary embodiment, the user computing device 112 is a desktop, laptop, smartphone, tablet, or other computing device, used by an employee or a customer. The user computing device 112 may include an application 114 installed on the user computing device 112 such as an application (e.g. client application or a web browser) that communicates with the computing device 102 via a communications network 114 and displays a user interface 116 by which the user can input information to, and receive information from, computing device 102. For example, the user computing device 112 includes a user interface 116 displayed within the application and/or webpage 114, as shown in FIG. 6. In addition, FIG. 8 illustrates a programmatic interface that can integrated with other technology such as an API to run title searches from Zillow™ or HomeliteTM

The communications network 114 can be any network over which information can be transmitted between devices communicatively coupled to the network. For example, one or more portions of communications network 114 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

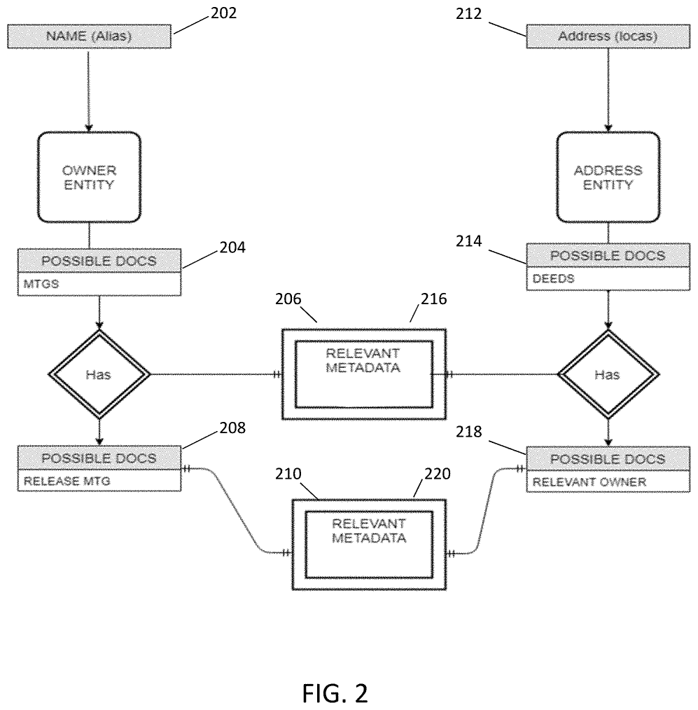

FIG. 2 illustrates a flowchart 200 for using system 100 for using a possible name and address to determine relevant metadata when retroactively building a genesis block for a real estate title chain, in accordance with an exemplary embodiment.

The Genesis block is used as a reference to the most current deed that will be the instrument of transfer to any future transaction on the property. FIG. 2 demonstrates how the disclosed system automation attempts to associate relevant documents during the discovery phase. In addition, the Genesis block is typically the key to beginning a search. In one embodiment, the three search operations are 1) search current owner at a particular address, 2) search two owners at a particular address (current and prior owners), and 3) 50 Year full rundown search to search all history of owners for up to 50 years if it exists on the property.

Artifacts may be utilized if the document metadata is in complete. This means the system needs to build the metadata from the image artifact or referenced artifact if it is not recorded in the registry such as (court, probate, divorce, medical) documents.

Embodiments enable a user to begin a title search by searching publicly available electronic records related to real property, such as a deed registry, using a name of a property address. The exemplary sequence begins at step 212, when a search is conducted of the publicly available electronic records using the property address. At step 214, the search returns one or more deeds associated with the property address. At step 216, the deeds are retrieved and analyzed using computing device 102, and the computing device 102 retrieves from the deeds relevant metadata associated with the deeds. At step 218, the computing device determines whether the deeds includes property owner(s). At step 220, the computing device retrieves from the deeds relevant metadata associated with the property owner(s).

A user can also search other publicly available electronic records related to real property, such as a local Registry of Deeds, using a name of a property owner. At step 202, a search is conducted of the publicly available electronic records using a name of a property owner. At step 204, the search returns one or more possible mortgage documents associated with the property owner, and the mortgage documents are retrieved and analyzed using computing device 102. If the computing device 102 determines that the mortgage documents includes relevant metadata for an outstanding mortgage, at step 206, the computing device 102 retrieves from the mortgages the relevant metadata for the mortgages. At step 208, the computing device 102 determines whether the mortgage documents includes a release or discharge. If the computing device 102 determines that the mortgage documents includes a release or discharge, at step 210, the computing device retrieves from the one or more mortgages relevant metadata for the mortgage discharge.

Using the above described process, the system can retrieve deeds and mortgages related to properties of interest as an initial step in performing a title search. Mortgages will typically be associated with a deed to place a lean on the property. This is how the registry tracks the lean. However, registries many times fail to manage the relation, this is why the disclosed system must investigate mortgage documents for the owners and investigate the deeds for the address to ensure properly and improperly linked mortgages are accounted for. The disclosed system is able to link the document in a current Title Summary.

In some embodiments, the computing device 102 reports any discoveries or linkage back to the registry. This seeks to remediate Registry issues by discovering, reporting, and repairing missing metadata and broken associations among documents.

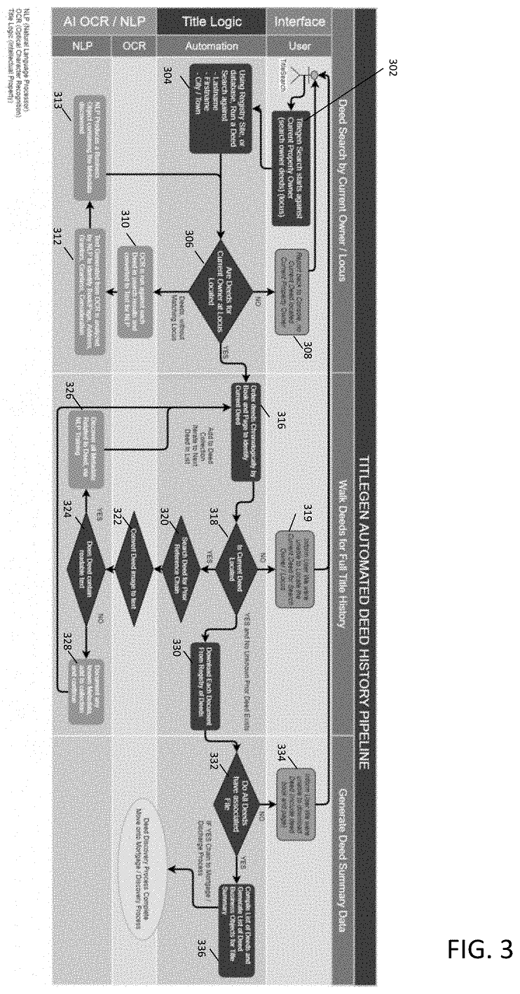

FIG. 3 illustrates generating an automated deed history pipeline using system 100, in accordance with an exemplary embodiment. As described herein, system 100 searches for and analyzes documents related to a parcel of real property in three stages: performing a deed search by current owner/locus, walking through the deeds for a full title history, and generating deed summary data.

At step 302, a user uses an user interface (e.g., interface 116) on a user computing device (e.g., user computing device 112) to initiate a deed search against a name, such as a name of a property owner, at the locus (location of property).

At step 304, the automation engine 104 uses the name at a registry site or database to perform a deed search against information associated with the property owner (late name, first name, city/town, etc.). In one embodiment, the computing device 102 performs Name(s) search, for all owners, provided, then will search prior owners if the search demands it. The Name Search will be further constricted by the Address relevant to the current deed discovered for transfer. FIG. 8 includes further detail that may be added at time of search. The user enters as much information as the user know about the property and the current owner(s). This is used by computing device 102 to investigate the property and any possible associations for the Title recording.

At step 306, the computing device 106 determines whether one or more deeds for the property owner at the locus have been located.

If no deeds for the property owner at the locus have been located, at step 308, that information is transmitted to user computing device 102 which displays on the user interface that no current deed was located for the property owner.

If one or more deeds are discovered but without a matching locus, at step 310, an OCR engine (e.g., OCR engine 106) runs an OCR conversion against each deed in the search results to covert the deed to text for NLP. OCR is the electronic conversion of images of typed, handwritten, or printed text into machine-encoded text. At step 312, the NLP engine 108 analyzes the text generated from the OCR conversion using NLP to identify information within the deeds, such as book/page identifiers, address, grantor, grantees, and considerations.

NLP will be used for two primary functions. First, entity detection with a trained Type system model. The Type system is trained to understand title data such as but not limited to Address, Name, book/page, consideration, grantors, grantees, plans, references, lots. Each document will be analyzed for entity type detection and will be investigated for findings with accuracy scoring to explain confidence. Second, using custom Dictionary for Syntax relationships. The custom Dictionary/Type System will allow the NLP engine 108 to understand the difference between an attorneys name that recorded the document vs. a name of a documented Owner in the document. This is the intelligence model that can expose key entity type relationships within documents for confident findings.

At step 313, the NLP engine 108 produces an object containing the metadata discovered associated with the property owner. The automation engine 106 uses the object produced by the NLP engine 108 to perform another search on the registry site or database to run a deed search against the metadata discovered, returning to step 306. At step 306, the computing device 106 again determines whether one or more deeds for the property owner at the locus have been located. When Metadata is not available, the NLP engine 108 discovers the Names via NLP to amend the metadata object in memory to continue and complete the search.

The object refers to an object stored in memory for reference by the program. The object is made up of the following properties stored in memory at any given moment:
int id;
int doc;
String image;
String type;
String description;
String date;
String town;
String street;
String locus;
int book;
int page;
List<String>grantors;
List<String>grantees;
List<String>refersto;
List<String>referredtoby;
double consideration;
BookPageBO dischargeBO;
List<DocumentMetaData>subors;
List<DocumentMetaData>asigmts;
List<DocumentMetaData>modfns;

If one or more deeds for the property owner at the locus have been located, at step 316, the automation engine 104 orders the deeds chronologically by book and page to identify the current (most recent) deed. At step 318, the computing device determines whether the current deed has been located.

The current deed is the most recent deed in chronology. Meaning, it is required in order to transfer ownership of the property. The deed is determined by Grantee names, Consideration and Date.

If no current deed is located, at step 319, the automation engine 104 transmits to user computing device 112 for display on the user interface 116 information indicating that no current deed was located for the searched property owner and locus.

If a current deed is located, at step 320, the automation engine 104 searches the current deed for a prior deed reference chain. At step 322, the OCR engine 106 converts the deed to text. At step 324, the NLP engine 108 determines whether the deed includes readable text. If the deed includes readable text, at step 326, the NLP engine 108 determines all metadata related to the deed via NLP. The automation engine 104 adds the deed to a collection of deeds in the deed reference chain and iterates to next deed in the chain, returning to step 316. If the deed does not include readable text, at step 328, the NLP engine 108 documents any known metadata, adds the deed to the collection of deeds in the deed reference chain and iterates to the next deed in the chain, returning to step 316.

The automation engine 104 continues walking through the deeds using the described steps until a current deed is located and no prior deeds exist, then proceeds to step 330. At step 330, the automation engine 104 downloads each deed from the deed registry.

At step 332, the automation engine 104 determines whether each downloaded deed includes an associated file. If all deeds do not have associated files, at step 334, the automation engine 104 displays on the user interface that the system was unable to download the deed (including deed book and page).

Associated files are files that refer to or are referred by another document and page. For example, deeds typically will have a mortgage related at time of deed creation. This means that a deed is referred to by a mortgage. If that particular mortgage is reviewed, you will find that the mortgage refers to the deed. This is the industries way of creating associated files (refers to and referred to by, and some just use a single refers to list to capture both meanings).

If all deeds do have associated files, at step 336, the automation engine 104 compiles a list of deeds and generates a list of deed objects for a title summary document. The list of deeds is the list of deeds associated with the address. The automation engine 104 records a deed object as follows:
int book;
int page;
String date;
String locus;
String town;
BookPageBO priorDeed;
double consideration;
List<String>grantors;
List<String>grantees;
List<String>address_refs;
List<BookPageBO>refersto;
List<BookPageBO>referredtoby;
String link;

As explained further herein, further steps are required to properly identify any associated documents. The disclosed system further discovers documents surrounding each deed according to the deeds grantees. The deed grantees are later searched for relevant documents which are then related back to each deed in the deed collection.

Based on the records that are analyzed, a chain of title is constructed and any potential defects (e.g., missing discharges, liens, or other title defects) are identified. The title summary document can be used to illustrate locations of risk along a transaction timeline as well as provide an overview of the property history. Based on this information for the parcel, a determination can be made as to whether or not to insure the title against claims as part of a particular real estate transaction.

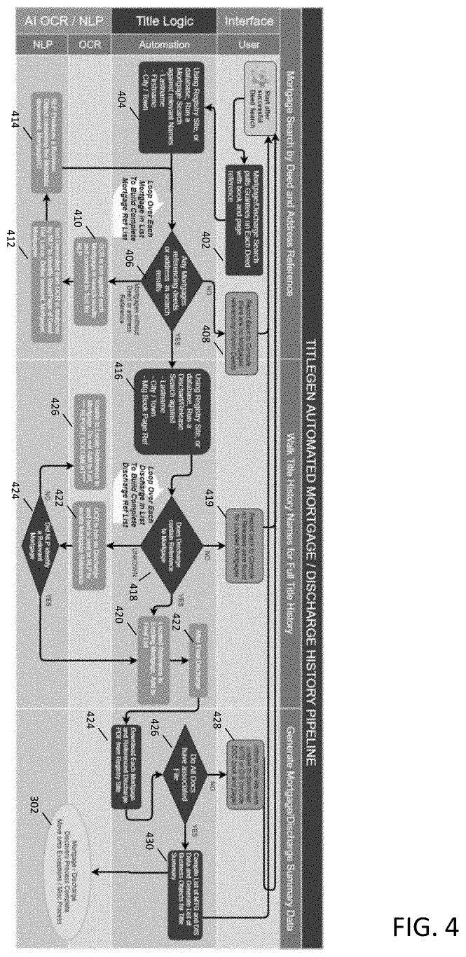

Once the deed discovery process is complete, the system moves onto the mortgage/discovery process described in FIG. 4.

FIG. 4 illustrates generating an automated mortgage/discharge history pipeline using system 100 and using the deed information obtained in FIG. 3, in accordance with an exemplary embodiment. As described herein, system 100 searches for and analyzes documents related to a parcel of real property in three stages: performing a mortgage search by deed and address reference, walking through title history names for a full title history, and generating mortgage/discharge summary data.

At step 402, a user initiates a mortgage and discharge search for deeds identified in FIG. 3 via user interface 116. The search retrieves grantees on each deed with book and page references. In one embodiment, this information is displayed on the user interface.

At step 404, the automation engine 104 uses a registry site or database to perform a mortgage search against information associated with one or more retrieved grantee names (late name, first name, city/town, etc.) from the previous deed search.

At step 406, the automation engine 104 determines whether one or more mortgages appear in the search result that reference deeds obtained in FIG. 3 or whether one or more mortgages appear in the search result that reference addresses associated with these deeds (also referenced below as known deeds or addresses).

If no such mortgages appear in the search result, at step 408, the automation engine 104 transmits information to user computing device 112 for display on the user interface 116 to indicate that there are no mortgages referencing known deeds.

If one or more mortgages are discovered but do not reference the known deeds or addresses, at step 410, the OCR engine 106 runs an OCR conversion against each mortgage document in the search results and converts the mortgage documents to text for NLP. At step 412, the NLP engine 108 analyzes the text generated from the OCR conversion using NLP to identify metadata, such as book/page of deed reference, locus, dollar amount, mortgager, and mortgages. At step 414, the NLP engine produces an object containing the metadata discovered. The automation engine 104 uses the object to perform another search on the registry site or dataset to run a mortgage search against the metadata, returning to step 406. At step 406, the computing device 106 again determines whether one or more mortgages reference deeds or addresses in the search result using the metadata. Basically the computing device 102 is performing an intelligent search that constantly checks to determine if missed data was discovered. For example, while searching a mortgage, the computing device 102 may find reference to a deed that is not yet in the collection. At that point, the computing device 102 may search that deed book and page to determine if it's relevant to the history of this address, if it is, the computing device 102 adds it to the deed collection.

If one or more mortgages are discovered in the search result that reference the known deeds and/or addresses, at step 416, the automation engine 104 performs a discharge/release search on a registry site or database using grantee name, city/town, and/or mortgage book page reference. In one embodiment, each search is typically contained to a particular registry. However, in some embodiments, external searches may be run against court systems, probate and other systems. At step 418, the automation engine 104 determines whether a discharge in the search results contains a reference to the mortgage.

If no discharge contains a reference to the mortgage, at step 419, the automation engine 104 displays in the user interface that no releases were found for the located mortgage.

If a discharge contains a reference to the mortgage, at step 420, the automation engine 104 adds the mortgage and/or discharge to a final list.

If the automation engine 104 is unable to determine whether a discharge contains a reference to the mortgage, at step 422, the OCR engine 106 runs a OCR conversion on the discharge document to convert to text, and the text is sent to the NLP engine 108 for using NLP to locate mortgage references. At step 424, the NLP engine 108 determines, using the NLP, whether a relevant mortgage is identified. If the NLP does not identify a relevant mortgage, at step 426, the system is unable to locate a discharge reference to the mortgage, and the discharge is not added to the final list. In some embodiments, the discharge document is reported to the user. If the NLP identifies a relevant mortgage, the automation engine 104 adds the mortgage and/or discharge to the final list, returning to step 420.

At step 422, the automation engine 104 investigates discharges to determine any mortgage association. Step 422 may be omitted in some embodiments.

At step 424, the automation engine 104 downloads each mortgage and referenced discharge PDF from the registry site.

At step 426, the automation engine 104 determines whether all downloaded mortgages and referenced discharges have associated files.

If all mortgages and referenced discharges do not have associated files, at step 428, the automation engine 104 transmits that information to user computing device 112 for display on the user interface 116 to indicate that the mortgages and/or discharges (includes DOC book and page) were unable to be downloaded.

If all mortgages and referenced discharges have associated files, at step 430, the automation engine 104 compiles a list of mortgages and discharge data and generates a list of objects for a title summary document. In one embodiment, the title summary document includes a title abstract. Based on the records that are analyzed, a chain of title is constructed and any potential defects (e.g., missing discharges, liens, or other title defects) are identified. This document can be used to illustrate locations of risk along a transaction timeline as well as provide an overview of the property history. Based on this information for the parcel, a determination can be made as to whether or not to insure the title against claims as part of a particular real estate transaction.

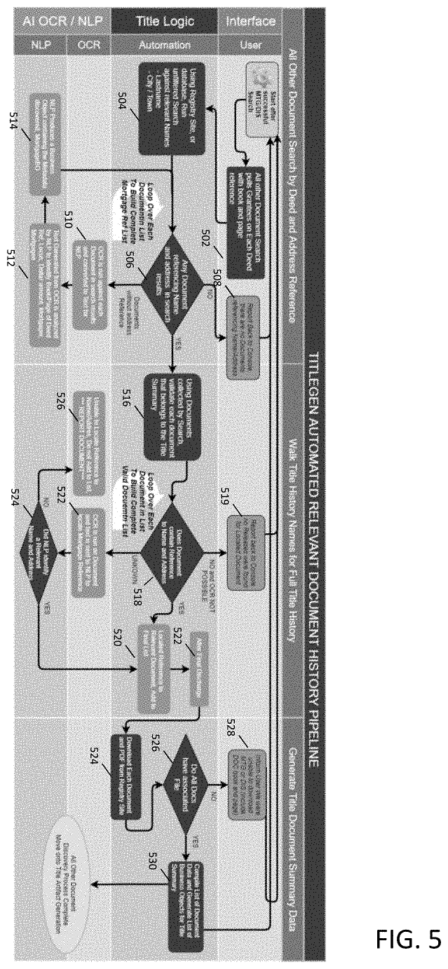

Once the mortgage and discharge process is complete, the system moves into exception/miscellaneous process described in FIG. 5.

FIG. 5 illustrates generating an automated relevant document history pipeline using system 100 after performing the mortgage and discharge search described in FIG. 4, in accordance with an exemplary embodiment. As described herein, system 100 searches for and analyzes documents (other than deeds/mortgages and related mortgage discharges) related to a parcel of real property in three stages: all other document search by deed and address reference, walking through relevant document history names for a full relevant document history, and generating relevant document summary data. Relevant documents include, but are not limited to, Federal Liens, State Liens, Trusts, Probate, Divorce, and Judgements.

The process of FIG. 5 performs a clean sweep, where the search scope is opened to find any documents for the particular owners that may be needed for reference in the title creation. This content may have been improperly catalogued, represented or filed and thus, the document must go through the pipeline for investigation. This search would run as a final search on all document types for each owner discovered in the deed collection. This is an unfiltered search for each owner without restricting the results by document type. This means we want all the history of documents related to the current and prior owners.

At step 502, a user initiates a document search via user interface 116 that retrieves grantees on each deed with book and page references. In one embodiment, this information is displayed on the user interface 116.

At step 504, the automation engine 106 performs an unfiltered search on a registry site or database against information associated with grantee names (late name, first name, city/town, etc.). Registry sites may include, for example, external systems for judgements, probate court records, and lien records for DOR.

At step 506, the automation engine 106 determines whether one or more documents returned in the unfiltered search result reference the grantee name and/or address associated with the grantee name in the search result.

If no documents are returned that reference the grantee name and/or associated address, at step 508, the automation engine 106 displays on the user interface that there are no documents that reference the grantee name and/or associated address.

If one or more documents are discovered without an address reference, at step 510, the OCR engine 106 performs an OCR conversion against each document and converts each document to text for NLP. At step 512, the NLP engine 108 analyzes the text generated from the OCR conversion using NLP to identify metadata such as book/page of deed reference, locus, dollar amount, mortgager, and mortgages. At step 514, the NLP engine 108 produces an obj ect containing the metadata discovered. The automation engine 106 uses the object to perform another document search on the registry site or database using the metadata, returning to step 506. At step 506, the computing device 106 determines whether one or more documents reference the grantee name or associated addresses in search result. This loops over each document in the list to build a complete mortgage reference list. The loop ends once a document that references both name and address is found. In some embodiments, the Entity Type system provides a confidence score that the Name is the correct Type of name (ex: John Doe: Relationship Grantee: 95% confident).

If one or more documents are returned that reference the grantee name and/or associated address, at step 516, the automation engine 106, using the documents collected by the search, validates each document that belongs to the title summary. The validation uses the prior logic to ensure it is for a validated owner at the address of search. At step 518, the automation engine 106 determines whether one or more documents contains a reference to the grantee name and address.

If the document does not contain a reference to the grantee name and associated address, at step 519, the automation engine 106 displays on the user interface that there are no documents that reference the grantee name and/or address.

If the document contains a reference to the grantee name and address, at step 520, the automation engine 106 adds the document to a final list.

If the automation engine 106 cannot determine whether a document contains a reference to the grantee name and associated address, at step 522, the OCR engine 106 runs a OCR conversion on the document to convert the document to text, and the text is transmitted to the NLP engine 108 to use NLP to locate a grantee name and address. At step 524, the NLP engine 108 determines whether the NLP identifies a grantee name and address. If the NLP did not identify a grantee name and address, at step 526, the system is unable to locate a reference to the grantee name and address, and the document is not added to the final list. If the NLP identifies a grantee name and associated address, the system proceeds to step 520 and the automation engine 104 adds the document to the final list.

At step 522, the automation engine 104 investigates discharges to determine any mortgage association. Step 522 may be omitted in some embodiments.

At step 524, the automation engine 106 downloads each document and any associated PDFs from the registry site.

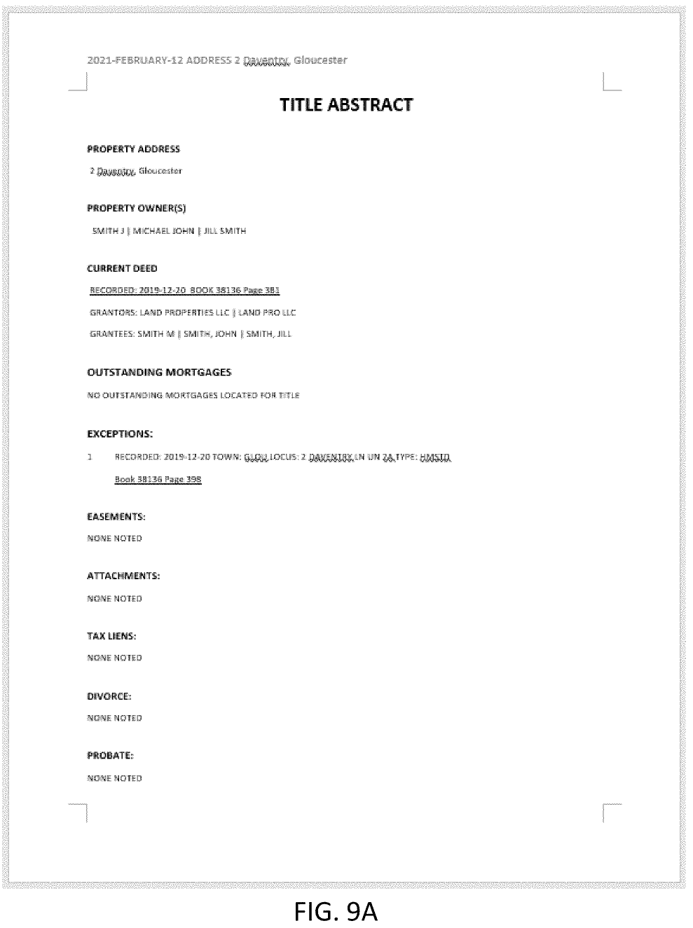

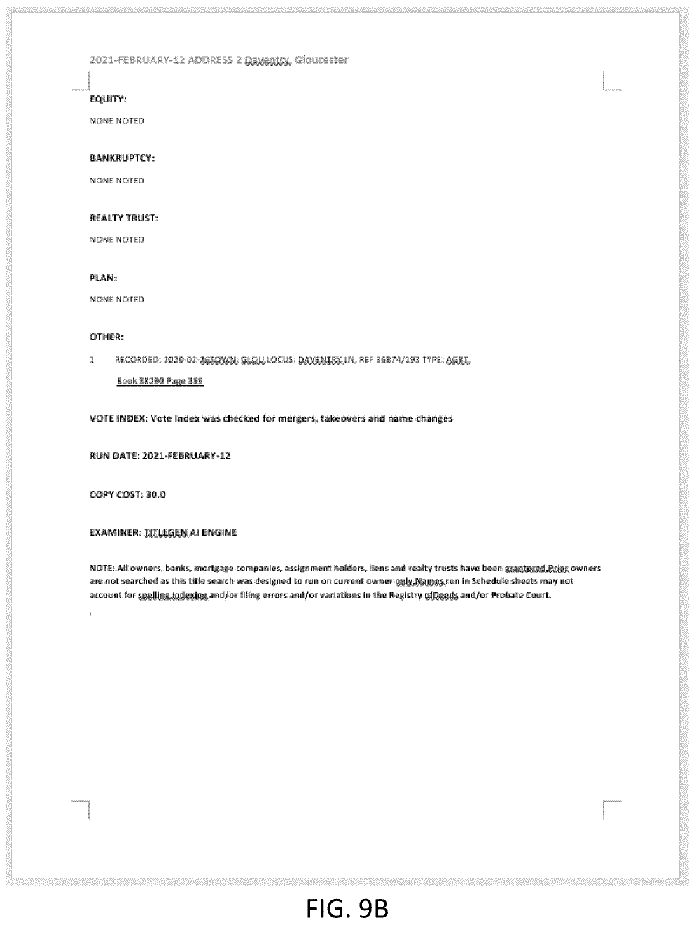

At step 526, the automation engine 106 determines whether all downloaded documents have associated files. If all documents do not have associated files, at step 528, the automation engine 106 transmits information for display on the user interface 116 that the documents were unable to be downloaded. If all documents have associated files, at step 530, the automation engine 106 compiles a list of document data and generate a list of objects for a title summary document, as shown in FIGS. 9A-9B.

Once the other document discovery process is complete, the system moves onto the title artifact generation. The Title Artifact is made up of the following objects: Title Summary page, Title Documents (combined pdf of chronologically ordered image documents most current to oldest), and a schedule sheet containing the history of documents included in the final summary with all metadata necessary for end user to review and to confirm the results.

Using the process described in FIGS. 2-5, an exemplary title abstract that results from the analysis of documentation related to a specific parcel of real property can include one or more of the following aspects as shown and described in the following example:
PAGE 1 of 6: 465 MAIN ST LOT G, REF 26485/19
TITLE ABSTRACT
PROPERTY ADDRESS:
465 MAIN ST LOT G, REF 26485/19
PROPERTY OWNERS:
CED CRE DEV LLC
CEDAR CREST DEVELOPMENT LLC
CURRENT DEED:
RECORDED: Sep. 8, 2014 BOOK/PAGE: 33529/483
GRANTORS: [COLBY, JOAN E TR, DOLE, REBECCA A TR, DGKR NOMINEE REALTY TRUST, COLBY J E T]
GRANTEES: [CED CRE DEV LLC, CEDAR CREST DEVELOPMENT LLC]
OUTSTANDING MORTGAGES:
RECORDED: May 16, 2007 BK/PG: 26842/302 CONS($): 859510.0
GRANTEES: [FIN FRE SEN FUN COR, FINANCIAL FREEDOM SENIOR FUNDING CORP]
RECORDED: Aug. 24, 2008 BK/PG: 9147/130 CONS($): 150000.0
GRANTEES: [INS FOR SAV IN NBPT & ITS VIC, INSTITUTION FOR SAVINGS IN NEWBURYPORT & ITS VICINITY]
RECORDED: Oct. 17, 1955 BK/PG: 4214/448 CONS($): 0.0
GRANTEES: [HAVERHILL SAVINGS BANK]
PAGE 2 of 6: 465 MAIN ST LOT G, REF 26485/19
PROPERTY DEEDS:
RECORDED: Sep. 8, 2014 CONSIDERATION: 115000.0 BK/PG: 33529/483
GRANTORS: [COLBY, JOAN E TR, DOLE, REBECCA A TR, DGKR NOMINEE REALTY TRUST, COLBY J E T]
GRANTEES: [CED CRE DEV LLC, CEDAR CREST DEVELOPMENT LLC]
RECORDED: Jan. 17, 2007 CONSIDERATION: 0.0 BK/PG: 26485/19
GRANTORS: [COLBY, JOAN E, COLBY, J E]
GRANTEES: [DGK NOM REA TRU, DGKR NOMINEE REALTY TRUST, COLBY, JOAN E TR, DOLE, REBECCA A TR]
RECORDED: Jan. 17, 2007 CONSIDERATION: 0.0 BK/PG: 26485/16
GRANTORS: [COLBY, JOAN E, COLBY, J E]
GRANTEES: [COLBY, J E, COLBY, JOAN E]
RECORDED: Aug. 28, 1959 CONSIDERATION: 0.0 BK/PG: 4594/106
GRANTORS: [COLBY, GEORGE E, COLBY, JOAN E, ENNES, BELLE L, ENNES, MANUEL G]
GRANTEES: [COLBY, GEORGE E, COLBY, JOAN E]
PAGE 3 of 6: 465 MAIN ST LOT G, REF 26485/19
MORTGAGES:
RECORDED: May 16, 2007 BK/PG: 26842/302 CONS($): 859510.0
GRANTORS: [COLBY, JOAN E, COLBY, J E]
RECORDED: Aug. 24, 1987 BK/PG: 9147/130 CONS($): 150000.0
GRANTORS: [COLBY, GEORGE E, COLBY, JOAN E, COLBY G E]
RECORDED: Aug. 16, 1976 BK/PG: 6269/168 DISCHARGE: BOOK: 6734 PAGE: 251 CONS($): 0.0
GRANTORS: [COLBY, GEORGE E, COLBY, JOAN E, G E COLBY]
RECORDED: Oct. 17, 1955 BK/PG: 4214/448 CONS($): 0.0
GRANTORS: [COLBY, GEORGE E, COLBY, JOAN E, ENNES, BELLE L, ENNES, MANUEL G BY AGT, MCGREGOR, A BRUCE ATTY]
RECORDED: Feb. 21, 1955 BK/PG: 4142/327 DISCHARGE: BOOK: 4230 PAGE: 520 CONS($): 0.0
GRANTORS: [COLBY, GEORGE E, COLBY, JOAN E, ENNES, BELLE L, ENNES, MANUEL G]
PAGE 4 of 6: 465 MAIN ST LOT G, REF 26485/19
DISCHARGES:
RECORDED: Sep. 5, 1980 BK/PG: 6734/251
GRANTORS: [NAUMKEAG TRUST CO, ]
RECORDED: Dec. 6, 1955 BK/PG: 4230/520
GRANTORS: [HAVERHILL SAVINGS BANK]
PAGE 5 of 6: 465 MAIN ST LOT G, REF 26485/19
EXCEPTIONS:
EASEMENTS: NONE NOTED
ATTACHMENTS:
TAX LIENS: NONE NOTED
DIVORCE: NONE NOTED
PROBATE: NONE NOTED
EQUITY: NONE NOTED
BANKRUPTCY: NONE NOTED
EALTY TRUST: NONE NOTED
PLAN: NONE LISTED
PAGE 6 of 6: 465 MAIN ST LOT G, REF 26485/19
VOTE INDEX: Vote Index was checked for mergers, takeovers and name changes
RUN DATE: Oct. 7, 2019
COPY COSTS: $0.0
EXAMINER: TITLEGEN AI ENGINE
NOTE:
All owners, banks, mortgage companies, assignment holders, liens and realty trusts have been grantored.
Prior owners are not searched as this title search was designed to run on current owner only.
Names run in Schedule sheets may not account for spelling, indexing and/or filing errors and/or variations in the Registry of Deeds and/or Probate Court.

FIG. 6 illustrates an exemplary user interface 600 with aspects of the above-described functionality represented in accordance with an exemplary embodiment. The user interface 600 displays information obtained as described in FIGS. 2-5. The user interface 600 may display a map 602 with a location of the property. The user interface 600 may display a title summary 604 with the property address, owner name, deed recordation date, and book/page number. The user interface 600 may further display a listing of any mortgages and discharges 606, including type, book, page, grantor, grantees, discharge and date. The user interface 608 further displays a listing of deeds, including book, page, reference, and date.

The user interface 600 may further display a listing of exceptions 610 and other documents 612, including type, book, page, reference, and date. Documents such as Homesteads, Probate, Trusts, Judgements, etc. all fall under Exceptions 610. Other type documents 612 may be a homeowner requesting a permit for business out of their home.

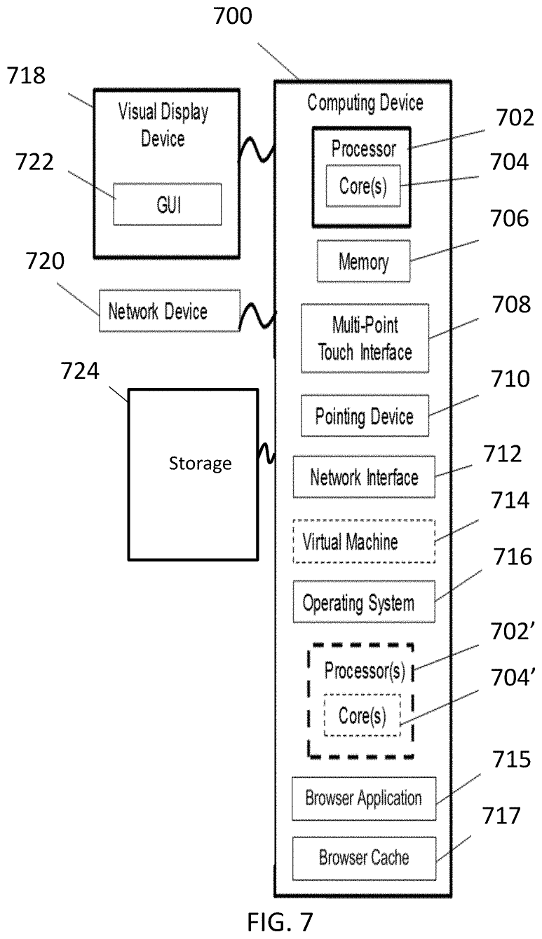

FIG. 7 is a block diagram of an example computing device 700 that can be used to perform one or more steps of the methods provided by exemplary embodiments. In an exemplary embodiment, computing device 700 is an computing device 102 as shown in FIG. 1 and/or a user computing device 112 shown in FIG. 1. Computing device 700 includes one or more non-transitory computer-readable media for storing one or more computer-executable instructions or software for implementing exemplary embodiments described herein. The non-transitory computer-readable media can include, but are not limited to, one or more types of hardware memory, non-transitory tangible media (for example, one or more magnetic storage disks, one or more optical disks, one or more USB flashdrives), and the like. For example, a memory 706 included in computing device 700 can store computer-readable and computer-executable instructions or software for implementing exemplary embodiments described herein. Computing device 700 also includes a processor 702 and an associated core 704, and optionally, one or more additional processor(s) 702′ and associated core(s) 704′ (for example, in the case of computer systems having multiple processors/cores), for executing computer-readable and computer-executable instructions or software stored in memory 706 and other programs for controlling system hardware. Processor 702 and processor(s) 702′ can each be a single core processor or multiple core (704 and 704′) processor. Computing device 700 may also include a browser application 715 and a browser cache 717 to enable a user to information on computing device 700.

Virtualization can be employed in computing device 700 so that infrastructure and resources in the computing device can be shared dynamically. A virtual machine 714 can be provided to handle a process running on multiple processors so that the process appears to be using only one computing resource rather than multiple computing resources. Multiple virtual machines can also be used with one processor.

Memory 706 can include a computer system memory or random access memory, such as DRAM, SRAM, EDO RAM, and the like. Memory 706 can include other types of memory as well, or combinations thereof In some embodiments, a customer can interact with computing device 700 through a graphical user interface (GUI) 722 associated with a visual display device 718, such as a touch screen display or computer monitor. Visual display device 718 may also display other aspects, elements and/or information or data associated with exemplary embodiments. Computing device 700 may include other I/O devices for receiving input from a customer, for example, a keyboard or any suitable multi-point touch interface 708, a pointing device 710 (e.g., a pen, stylus, mouse, or trackpad). The keyboard 708 and pointing device 710 may be coupled to visual display device 718. Computing device 700 may include other suitable conventional I/O peripherals.

Computing device 700 can also include one or more databases 724, such as a hard-drive, CD-ROM, or other computer readable media, for storing data and computer-readable instructions and/or software, which implements embodiments of the system, as described herein, or portions thereof. Exemplary database 724 can also store one or more databases for storing any suitable information required to implement exemplary embodiments.

Computing device 700 can include a network interface 712 configured to interface via one or more network devices with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 712 can include a built-in network adapter, network interface card, PCMCIA network card, card bus network adapter, wireless network adapter, USB network adapter, modem or any other device suitable for interfacing computing device 700 to any type of network capable of communication and performing the operations described herein. Moreover, computing device 700 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

Computing device 700 can run any operating system 716, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 716 can be run in native mode or emulated mode. In an exemplary embodiment, the operating system 716 can be run on one or more cloud machine instances.

FIG. 8 illustrates a programmatic interface 800 that can integrated with other technology such as an API to run title searches from Zillow™ or Homelite™, in accordance with an example embodiment. In the example embodiment, the API interface 800 uses open API REST web service standards. The user enters into interface 800 as much information as the user know about the property and the current owner(s). This is used by computing device 102 to investigate the property and any possible associations for the Title recording.

FIGS. 9A-9B illustrate a title summary document (title abstract) created by the disclosed systems and methods, in accordance with an example embodiment. The title abstract is a record of the title history of the property, including transfers, liens, and legal actions that are connected to the property.

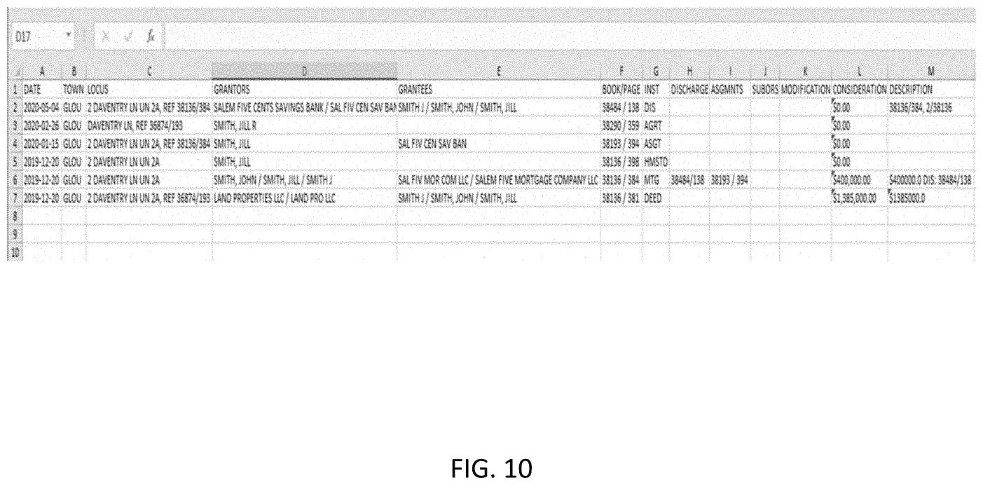

FIG. 10 illustrates a list of deeds generated by the disclosed systems and methods, in accordance with an example embodiment.

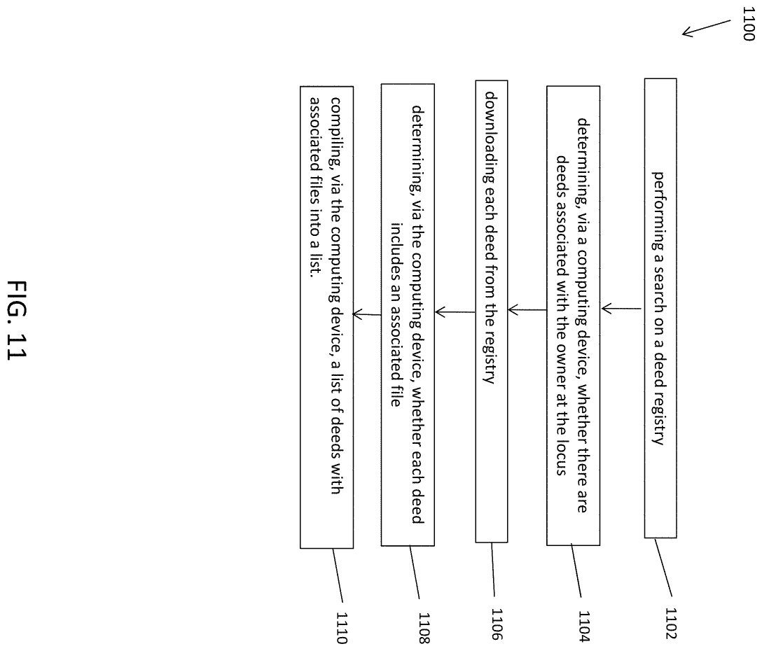

FIG. 11 is a method 1100 for property title evaluation in accordance with an exemplary embodiment. In step 1102, the method includes performing a search on a deed registry using a name of a property owner associated with a locus. In step 1104, the method includes determining, via a computing device, whether there are deeds associated with the owner at the locus. In step 1106, the method includes downloading, via the computing device, each deed associated with the owner at the locus from the registry. In step 1108, the method includes determining, via the computing device, whether each deed includes an associated file. In step 1110, the method includes compiling, via the computing device, a list of deeds with associated files into a list.

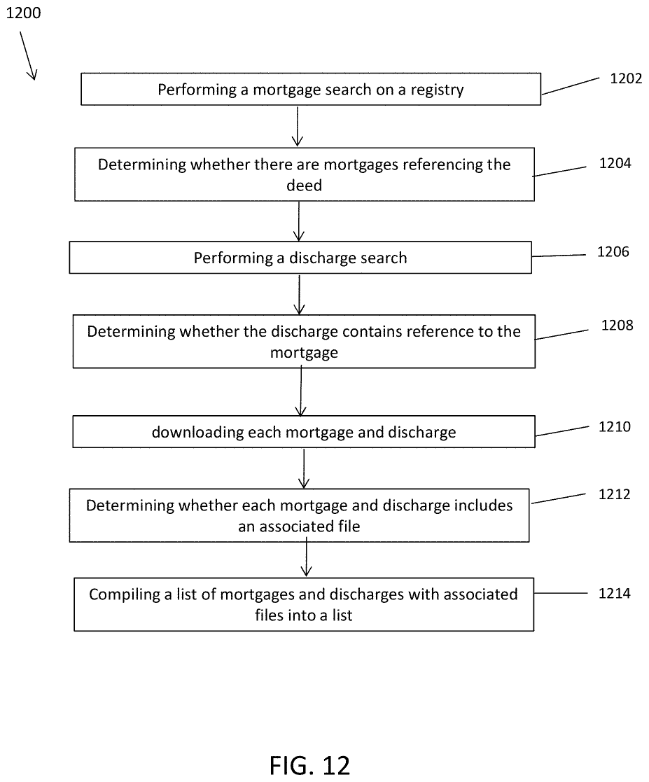

FIG. 12 is a method 1200 for property title evaluation in accordance with an exemplary embodiment. In step 1202, the method includes performing a mortgage search on a registry using a name of a property owner associated with a deed and an address associated with the deed. In step 1204, the method includes determining, via a computing device, whether there are mortgages referencing the deed or the address. In step 1206, the method includes performing a discharge search on a registry using the name of the property owner associated with the deed, an address associated with the deed, and/or mortgage book/page reference. In step 1208, the method includes determining, via the computing device, whether the discharge contains reference to the mortgage. In step 1210, the method includes downloading, via the computing device, each mortgage and discharge from the registry. In step 1212, the method includes determining, via the computing device, whether each mortgage and discharge includes an associated file. In step 1214, the method includes compiling, via the computing device, a list of mortgages and discharges with associated files into a list.

The description herein is presented to enable any person skilled in the art to create and use a computer system configuration and related method and systems for property title evaluation. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes multiple system elements, device components or method steps, those elements, components or steps can be replaced with a single element, component or step. Likewise, a single element, component or step can be replaced with multiple elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Portions or all of the embodiments of the present invention may be provided as one or more computer-readable programs or code embodied on or in one or more non-transitory mediums. The mediums may be, but are not limited to a hard disk, a compact disc, a digital versatile disc, a flash memory, a PROM, a RAM, a ROM, or a magnetic tape. In general, the computer-readable programs or code may be implemented in many computing languages.

Exemplary flowcharts are provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

In order to realize aspects of the above-described functionality, one of skill in the art may implement a computer program, which may also be referred to or described as a program, software, a software application, a module, a software module, a script, or code, may be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass databases for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable database, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

Control of the various systems described in this specification, or portions of them, can be implemented in a computer program product that includes instructions that are stored on one or more non-transitory machine-readable storage media, and that are executable on one or more processing devices. The systems described in this specification, or portions of them, can each be implemented as an apparatus, method, or electronic system that may include one or more processing devices and memory to store executable instructions to perform the operations described in this specification.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML, page, to a user device, e.g., for purposes of displaying data to and receiving user input from a user interacting with the user device, which acts as a client. Data generated at the user device, e.g., a result of the user interaction, can be received from the user device at the server.

While this description contains many specific implementation details, these should not be construed as limitations on the scope of any invention or on the scope of what may be claimed, but rather as descriptions of features that may be specific to particular embodiments of particular inventions. Certain features that are described in this disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

We claim:

1. A method for property title evaluation comprising:
performing a search on a deed registry using a name of a property owner associated with a locus;
determining, via a computing device, whether there are deeds associated with the owner at the locus;
downloading, via the computing device, each deed associated with the owner at the locus from the registry;
determining, via the computing device, whether each deed includes an associated file; and
compiling, via the computing device, a list of deeds with associated files into a list.

2. A method for property title evaluation comprising:
performing a mortgage search on a registry using a name of a property owner associated with a deed and an address associated with the deed;
determining, via a computing device, whether there are mortgages referencing the deed or the address;
performing a discharge search on a registry using the name of the property owner associated with the deed, an address associated with the deed, and/or mortgage book/page reference;
determining, via the computing device, whether the discharge contains reference to the mortgage;
downloading, via the computing device, each mortgage and discharge from the registry;
determining, via the computing device, whether each mortgage and discharge includes an associated file; and
compiling, via the computing device, a list of mortgages and discharges with associated files into a list.
